(19) United States
(12) Patent Application Publication
(10) Pub. No.: US 2025/0301241 A1
(43) Pub. Date: Sep. 25, 2025

(54) DETECTION CIRCUIT AND IMAGE GENERATION DEVICE

(71) Applicant: Panasonic Intellectual Property Management Co., Ltd., Osaka (JP)

(72) Inventor: Shigetaka KASUGA, Osaka (JP)

(21) Appl. No.: 19/230,936

(22) Filed: Jun. 6, 2025

Related U.S. Application Data
(63) Continuation of application No. PCT/JP2023/043886, filed on Dec. 7, 2023.

(30) Foreign Application Priority Data
Dec. 21, 2022 (JP) 2022-204520

(51) Int. Cl. H04N 25/772; H04N 25/40; H04N 25/42; H04N 25/766

(52) U.S. Cl. CPC H04N 25/772; H04N 25/41; H04N 25/42; H04N 25/766

(57) ABSTRACT

A detection circuit includes an I/V converter configured to convert a conduction current flowing in a piezoelectric element into a voltage, an integrator configured to integrate the voltage, and a switch configured to reset the integrator by use of a reset pulse.

### CROSS REFERENCE TO RELATED APPLICATION

This application is a continuation of International Application No. PCT/JP2023/043886 filed on Dec. 7, 2023, entitled “DETECTION CIRCUIT AND IMAGE GENERATION DEVICE”, which claims priority under 35 U.S.C. Section 119 of Japanese Patent Application No. 2022-204520 filed on Dec. 21, 2022, entitled “DETECTION CIRCUIT AND IMAGE GENERATION DEVICE”. The disclosures of the above applications are incorporated herein by reference.

### BACKGROUND OF THE INVENTION

### Field of the Invention

The present invention relates to a detection circuit that detects a scanning position of light, and an image generation device including the detection circuit.

### Description of Related Art

To date, an image generation device that generates an image by performing scanning with light modulated by a video signal has been known. In this device, for example, an image for one frame is generated by, while performing scanning in the horizontal direction with light in a first cycle, performing scanning in the vertical direction with light in a second cycle longer than the first cycle. The first cycle corresponds to the cycle for one line of the video signal, and the second cycle corresponds to the frame cycle of the video signal.

An image generation device of this type is described in Japanese Laid-Open Patent Publication No. 2018-155989, for example. In this device, by a light deflector that uses a piezoelectric actuator as a driving source, scanning is performed with light in the horizontal direction and the vertical direction. In this case, by detecting the scanning position of light in the vertical direction, it is possible to smoothly control the position of the image region in the vertical direction. In the light deflector, for such position detection, a piezoelectric element is placed, for example.

As a detection circuit using a piezoelectric element, a detection circuit described in Japanese Laid-Open Patent Publication No. 2008-033567 is known, for example. In general, it is known that the magnitude of the current that flows in a piezoelectric element is proportional to the speed at which the piezoelectric element expands and contracts. That is, the conduction current of the piezoelectric element corresponds to the derivative of the expansion and contraction state of the piezoelectric element. Therefore, in the above detection circuit, the conduction current of the piezoelectric element is converted into a voltage by an I/V converter, and the converted voltage is integrated by an integrator, whereby a detection signal indicating the expansion and contraction state of the piezoelectric element is generated.

In the image generation device having the above configuration, for example, control of shifting, in the vertical direction, the rendering region in accordance with change in the line of sight of a user can be performed. In this case, when the range of scanning with light in the vertical direction is changed, the image rendering range is shifted in the vertical direction. In this control, if the scanning position of light in the vertical direction is monitored, whether the range of scanning with light is being applied to the position in the vertical direction based on a line-of-sight detection signal can be determined by a controller, and when the scanning position of light is not being appropriately applied, a driving signal that is applied can be corrected by the controller.

However, in the detection circuit described in Japanese Laid-Open Patent Publication No. 2008-033567 above, since it takes time until the integrated value by the integrator stabilizes, it is difficult to use the detection signal in feedback control for a short cycle (one frame cycle) as in the image generation device.

### SUMMARY OF THE INVENTION

A first aspect of the present invention relates to a detection circuit. The detection circuit according to this aspect includes: an I/V converter configured to convert a conduction current flowing in a piezoelectric element into a voltage; an integrator configured to integrate the voltage; and a switch configured to reset the integrator by use of a reset pulse.

In the detection circuit according to the present aspect, since the integrator can be reset by the reset pulse, there is no need to wait until the integrated value by the integrator stabilizes. Therefore, when this detection circuit is used in detection of the scanning position of light in the image generation device, the scanning position of light can be quickly and accurately detected.

A second aspect of the present invention relates to an image generation device. The image generation device according to this aspect includes: a light source; a scanner configured to perform scanning with light emitted from the light source; a detection circuit configured to detect a scanning position of the light; and a controller configured to control the light source and the scanner, based on a video signal. The scanner includes a piezoelectric element for detecting the scanning position of the light. The detection circuit includes an I/V converter configured to convert a conduction current flowing in the piezoelectric element into a voltage, an integrator configured to integrate the voltage, and a switch configured to reset the integrator by use of a reset pulse. The controller outputs the reset pulse to the detection circuit at a predetermined timing to cause the switch to operate.

In the image generation device according to the present aspect, since the scanning position of light is detected by the detection circuit having a configuration similar to that of the first aspect above, the scanning position of light can be quickly and accurately detected. Therefore, also when control of shifting the rendering region in accordance with change in the line of sight of the user is performed as described above, the scanning position of light can be smoothly and highly accurately controlled to a predetermined position, based on the detection signal from the detection circuit.

The effects and the significance of the present invention will be further clarified by the description of the embodiment below. However, the embodiment below is merely an example for implementing the present invention. The present invention is not limited to the description of the embodiment below in any way.

### BRIEF DESCRIPTION OF THE DRAWINGS

FIG. 1 is a perspective view schematically showing a configuration of AR glasses according to an embodiment;

FIG. 2 schematically shows a configuration of a projection unit according to the embodiment;

FIG. 3 shows a configuration of a circuitry of an image generation device according to the embodiment;

FIG. 4 is a plan view showing a configuration of a second scanner according to the embodiment;

FIG. 5A shows a simulation waveform of a driving signal (voltage) when a rendering region of an image is changed in the vertical direction for each frame according to the embodiment;

FIG. 5B shows a waveform obtained through simulation of a current (monitoring current) that flows in a piezoelectric element when a piezoelectric actuator is driven by the driving signal in FIG. 5A according to the embodiment;

FIG. 6 shows a voltage waveform (simulation waveform) when the monitoring current in FIG. 5B is converted into a voltage by an I/V converter according to the embodiment;

FIG. 7 shows a configuration of a mirror position detection circuit according to the embodiment;

FIG. 8 shows a configuration of a mirror position detection circuit according to a comparative example;

FIG. 9A shows a simulation waveform of a detection signal when the mirror position detection circuit according to the comparative example is used;

FIG. 9B shows the waveform of the detection signal when the mirror position detection circuit according to the embodiment is used;

FIG. 10 is a time chart showing an application timing of a reset pulse according to the embodiment;

FIG. 11 shows a simulation waveform of the detection signal when the reset pulse is applied in a flyback period according to the embodiment;

FIG. 12 is a time chart showing an application timing of the reset pulse according to Modification 1;

FIG. 13 shows a simulation waveform of the detection signal when the reset pulse is applied in a DC period according to Modification 1; and

FIG. 14 shows a configuration of the mirror position detection circuit according to Modification 2.

It is noted that the drawings are solely for description and do not limit the scope of the present invention in any way.

### DETAILED DESCRIPTION

Hereinafter, an embodiment of the present invention will be described with reference to the drawings. In the embodiment below, an example in which the present invention is applied to an image generation device for AR glasses is shown. However, the embodiment below is an example of embodiments of the present invention, and the present invention is not limited to the embodiment below in any way. For example, not limited to an image generation device for AR glasses, the present invention is also applicable to an image generation device for AR goggles, VR glasses, VR goggles, vehicle-mounted head-up displays, and the like.

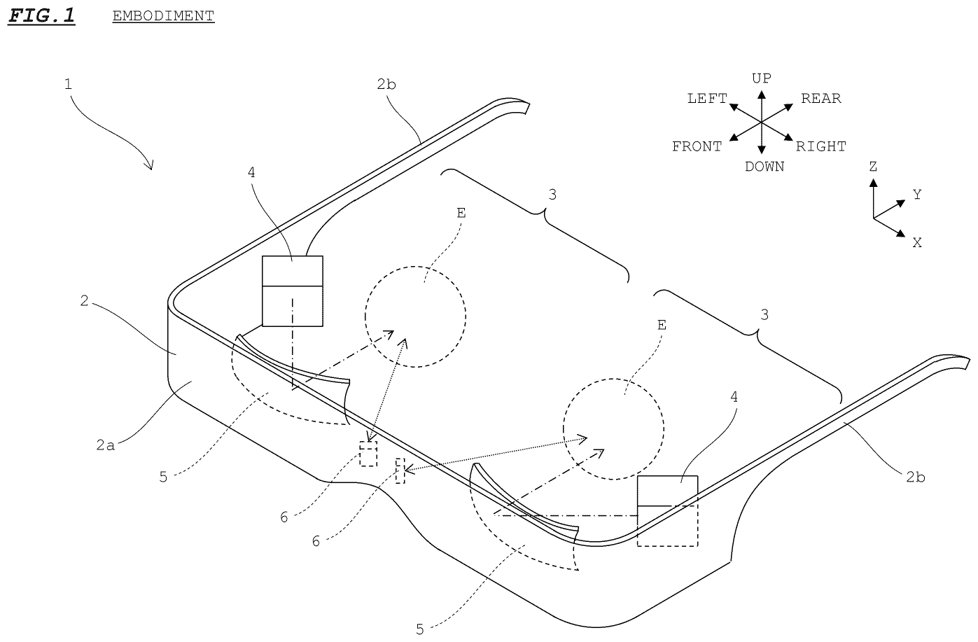

FIG. 1 is a perspective view schematically showing a configuration of AR glasses 1.

In FIG. 1, front, rear, left, right, up, and down directions of the AR glasses 1 and X, Y, and Z-axes orthogonal to each other are indicated. The X-axis positive direction, the Y-axis positive direction, and the Z-axis positive direction correspond to the right direction, the rear direction, and the up direction of the AR glasses 1, respectively.

The AR glasses 1 include a frame 2 and a pair of image generation devices 3. The pair of image generation devices 3 is in symmetry with each other with respect to a Y-Z plane passing through the center of the AR glasses 1. Each image generation device 3 includes a projection unit 4, a half mirror 5, and a detection unit 6. Similar to typical eyeglasses, the AR glasses 1 are worn on the head of a user.

The frame 2 is composed of a front face part 2a and a pair of support parts 2b. The pair of support parts 2b extend rearward from the right end and the left end of the front face part 2a. When the frame 2 is worn by the user, the front face part 2a is positioned in front of a pair of eyes E of the user. The front face part 2a is formed from a transparent material (e.g., resin, etc.).

The projection unit 4 is installed on the inner face of each support part 2b. The projection unit 4 projects light modulated by a video signal, to a corresponding half mirror 5.

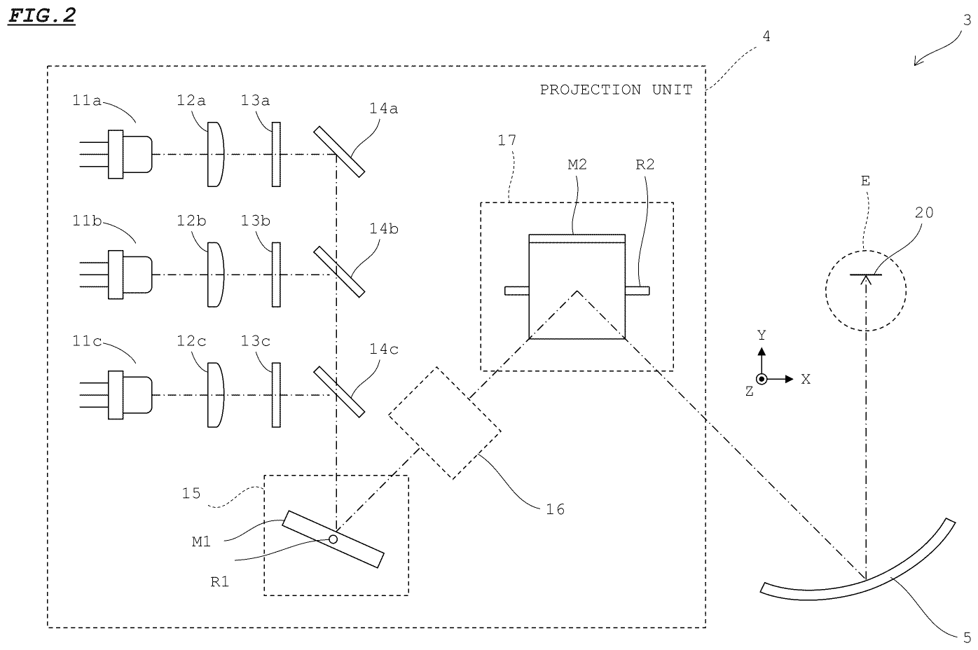

Each half mirror 5 is installed on the inner face of the front face part 2a. The half mirror 5 reflects the light projected from the corresponding projection unit 4 to the eye E of the user, and transmits therethrough light advancing in the front-rear direction. The light from the projection unit 4 reflected by the half mirror 5 is applied to the central fossa positioned at the center of the retina in the eye E. Accordingly, the user can visually grasp a frame image 20 (see FIG. 2) generated by the image generation device 3. Since the user can see the front of the AR glasses 1 through the half mirror 5, the user can visually grasp the state in front of the AR glasses 1 and the frame image 20 generated by the image generation device 3 superposed with each other.

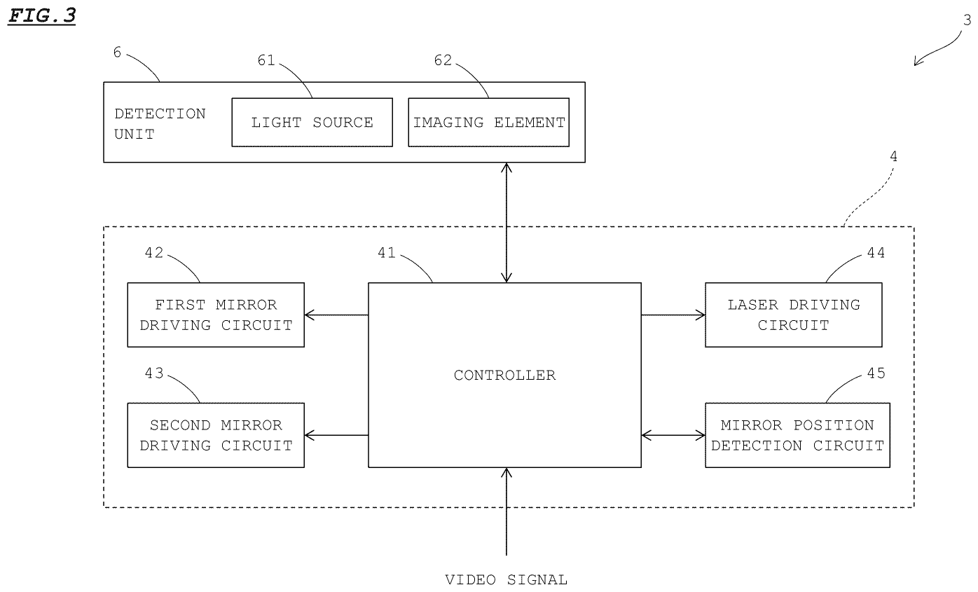

The pair of detection units 6 are installed on the inner face of the front face part 2a, and are positioned between the pair of half mirrors 5. The detection units 6 are used for detecting the line of sight of the user. Detection of the line of sight of the user will be described later with reference to FIG. 3.

FIG. 2 schematically shows a configuration of the projection unit 4.

The projection unit 4 includes light sources 11a, 11b, 11c, collimator lenses 12a, 12b, 12c, apertures 13a, 13b, 13c, a mirror 14a, dichroic mirrors 14b, 14c, a first scanner 15, a relay optical system 16, and a second scanner 17.

The light sources 11a, 11b, 11c are each a semiconductor laser light source, for example. The light source 11a emits laser light having a red wavelength included in a range of 635 nm or more and 645 nm or less, the light source 11b emits laser light having a green wavelength included in a range of 510 nm or more and 530 nm or less, and the light source 11c emits laser light having a blue wavelength included in a range of 440 nm or more and 460 nm or less.

In the present embodiment, a color image is generated as the frame image 20 described later, and thus, the projection unit 4 includes the light sources 11a, 11b, 11c that can emit red, green, and blue laser lights. When an image in a single color is displayed as the frame image 20, the projection unit 4 may include only one light source that corresponds to the color of the image. The projection unit 4 may be configured to include two light sources whose emission wavelengths are different from each other.

The lights emitted from the light sources 11a, 11b, 11c are converted into collimated lights by the collimator lenses 12a, 12b, 12c, respectively. The lights having passed through the collimator lenses 12a, 12b, 12c are shaped into approximately circular beams by the apertures 13a, 13b, 13c, respectively.

The mirror 14a substantially totally reflects the red light having passed through the aperture 13a. The dichroic mirror 14b reflects the green light having passed through the aperture 13b, and transmits therethrough the red light reflected by the mirror 14a. The dichroic mirror 14c reflects the blue light having passed through the aperture 13c, and transmits therethrough the red light and the green light having advanced via the dichroic mirror 14b. The mirror 14a and the two dichroic mirrors 14b, 14c are placed such that the optical axes of the lights in the respective colors emitted from the light sources 11a, 11b, 11c are caused to coincide with each other.

The first scanner 15 reflects the lights having advanced via the dichroic mirror 14c. The first scanner 15 is an MEMS (Micro Electro Mechanical System) mirror, for example. The first scanner 15 is provided with a configuration that causes a first mirror M1 on which the lights having advanced via the dichroic mirror 14c are incident, to rotate about a rotation axis R1, which is parallel to the Z-axis direction, in accordance with a driving signal. Through rotation of the first mirror M1, the light reflection direction changes. Accordingly, the lights reflected by the first mirror M1 are scanned in the X-axis direction (horizontal direction) on the retina of the eye E.

The relay optical system 16 directs the lights reflected by the first scanner 15 toward the center of a second mirror M2 of the second scanner 17. That is, the lights incident on the first scanner 15 are deflected at a predetermined deflection angle by the first mirror M1. The relay optical system 16 directs each light at the deflection angle, toward the center of the second mirror M2. The relay optical system 16 has a plurality of mirrors, and causes the plurality of mirrors to reflect the lights reflected by the first scanner 15, toward the second scanner 17. Accordingly, a long optical path length can be realized inside the relay optical system 16, and the deflection angle of each light when viewed from the second mirror M2 can be suppressed.

The second scanner 17 reflects the lights having advanced via the relay optical system 16. The second scanner 17 is an MEMS mirror. The second scanner 17 causes the second mirror M2 on which the lights having advanced via the relay optical system 16 are incident, to rotate about a rotation axis R2, which is parallel to an X-Y plane, in accordance with a driving signal. Through rotation of the second mirror M2, the light reflection direction changes. Accordingly, on the retina of the eye E, the lights scanned in the X-axis direction (horizontal direction) with the first scanner 15 are also scanned in the Z-axis direction (vertical direction).

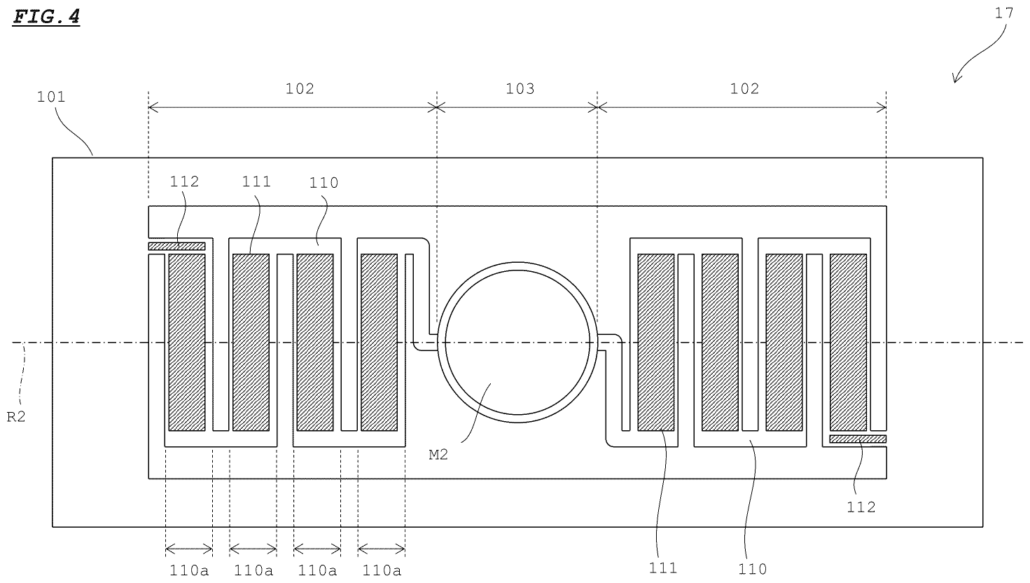

The configuration of the second scanner 17 will be described later with reference to FIG. 4.

The lights reflected by the second scanner 17, i.e., the lights emitted from the projection unit 4, are reflected by the half mirror 5 to form a frame image 20 on the retina of the eye E. That is, the light (the lights emitted from the light sources 11a to 11c) modulated by the video signal is scanned in the horizontal direction (the X-axis direction) and the vertical direction (the Z-axis direction) with the first scanner 15 and the second scanner 17, whereby the frame image 20 for one frame is formed on the retina of the eye E.

FIG. 3 shows a configuration of a circuitry of the image generation device 3.

The detection unit 6 includes a light source 61 and an imaging element 62, and is connected to a controller 41 of the projection unit 4. The light source 61 is an LED that emits light having an infrared wavelength, for example. The imaging element 62 is a CMOS image sensor or a CCD image sensor, for example. The light source 61 applies light to the eye E of the user in accordance with an instruction from the controller 41. The imaging element 62 captures an image of the eye E of the user in accordance with an instruction from the controller 41, and outputs the captured image to the controller 41.

The projection unit 4 includes the controller 41, a first mirror driving circuit 42, a second mirror driving circuit 43, a laser driving circuit 44, and a mirror position detection circuit 45.

The controller 41 includes an arithmetic processing unit such as a CPU and an FPGA, and a memory. The controller 41 processes a video signal from an external device to control each component of the projection unit 4. Based on the captured image from the detection unit 6, the controller 41 detects the line of sight of the user by the dark pupil method, the bright pupil method, the corneal reflex method, or the like, for example. Based on the detected line of sight of the user, the controller 41 acquires the viewpoint position in the frame image 20 formed on the retina of the user.

The first mirror driving circuit 42 drives the first mirror M1 of the first scanner 15 in accordance with a driving signal from the controller 41. The second mirror driving circuit 43 drives the second mirror M2 of the second scanner 17 in accordance with a driving signal from the controller 41.

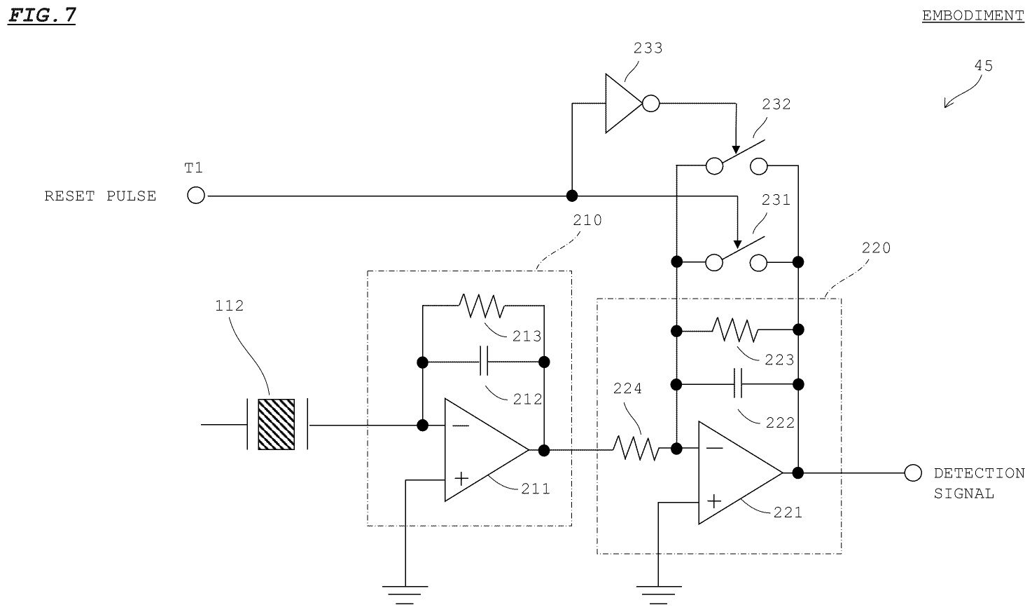

The mirror position detection circuit 45 outputs, to the controller 41, a detection signal according to the drive state of the second mirror M2 in the second scanner 17, i.e., the scanning position of light in the vertical direction (the Z-axis direction). The configuration of the mirror position detection circuit 45 will be described later with reference to FIG. 7.

Based on the detection signal from the mirror position detection circuit 45, the controller 41 outputs a driving signal to the second mirror driving circuit 43 such that the second mirror M2 rotates in the vertical direction (the Z-axis direction) in a desired drive waveform. In addition, based on the line of sight of the user detected by the detection unit 6, and the detection signal from the mirror position detection circuit 45, the controller 41 controls the second mirror driving circuit 43 such that the frame image 20 is depicted at the position of the line of sight.

The image generation device 3 may further include a detection circuit that detects the drive state of the first mirror M1 in the first scanner 15, i.e., the scanning position of light in the horizontal direction (the X-axis direction). In this case, based on a detection signal from this detection circuit, the controller 41 controls the first mirror driving circuit 42 such that the first mirror M1 rotates in the horizontal direction (the X-axis direction) in a desired drive waveform.

FIG. 4 is a plan view showing a configuration of the second scanner 17.

As shown in FIG. 4, in the present embodiment, the second scanner 17 is composed of a meander-type MEMS mirror (light deflector). However, the second scanner 17 is not limited to the meander-type MEMS mirror, and may be a light deflector having another configuration.

The second scanner 17 includes a support part 101, a pair of drive parts 102, and a movable part 103. The support part 101 is a frame-shaped member having a predetermined thickness, and is composed of a silicon substrate, for example. In a plan view, the support part 101 has a rectangular contour.

Each drive part 102 includes a substrate 110 whose one end is connected to the support part 101 and whose other end is connected to the movable part 103, and four piezoelectric actuators 111 formed on the upper face of the substrate 110. The substrate 110 has a meander shape that meanders in a direction perpendicular to the rotation axis R2. The thickness of the substrate 110 is constant. The substrate 110 is formed integrally with the support part 101, from a material similar to that of the support part 101.

The four piezoelectric actuators 111 are respectively placed on the upper faces in four regions 110a, of the substrate 110, that extend in a direction perpendicular to the rotation axis R2. Each piezoelectric actuator 111 has a configuration in which a piezoelectric body having a constant thickness is sandwiched by an upper electrode and a lower electrode. The piezoelectric body is formed from PZT, for example. The upper electrode and the lower electrode are each formed from platinum, for example. Through application of a voltage (driving signal) between the upper electrode and the lower electrode, the piezoelectric actuator 111 (piezoelectric body) expands and contracts. Accordingly, the substrate 110 bends, whereby a driving force for driving the movable part 103 is generated.

The movable part 103 is supported by the pair of drive parts 102. The movable part 103 is formed integrally with the substrates 110 and the support part 101, from a material similar to that of the substrates 110 of the drive parts 102. In a plan view, the movable part 103 is circular. The shape of the movable part 103 may be another shape such as a square or the like. The thickness of the movable part 103 is a thickness similar to that of the substrates 110. On the back face of the movable part 103, a rib for suppressing warpage of the movable part 103 may be formed. On the upper face of the movable part 103, the second mirror M2 described above is formed. When the reflectance of the upper face of the movable part 103 is high, the upper face of the movable part 103 may serve as the second mirror M2.

When a driving voltage having the same phase has been applied to the odd-numbered piezoelectric actuators 111 counted from the movable part 103 side, the piezoelectric bodies of these piezoelectric actuators 111 are deformed and the odd-numbered substrates 110 (the regions 110a) vibrate in a bending manner. At this time, a driving voltage having a phase opposite to that of the driving voltage applied to the odd-numbered piezoelectric actuators 111 is applied to the even-numbered piezoelectric actuators 111 counted from the movable part 103 side. Accordingly, the piezoelectric bodies in the piezoelectric actuators 111 are deformed and the even-numbered substrates 110 (the regions 110a) are deformed in a bending manner. Thus, by the respective substrates 110 being deformed, the movable part 103 rotates about the rotation axis R2.

Further, in the substrate 110 of each drive part 102, a piezoelectric element 112 is placed on the upper face of a portion connected to the support part 101. Similar to the piezoelectric actuator 111, the piezoelectric element 112 has a configuration in which a piezoelectric body is sandwiched by an upper electrode and a lower electrode.

The mirror position detection circuit 45 shown in FIG. 3 outputs detection signals that are respectively based on deformations of these two piezoelectric elements 112. Here, when the movable part 103 and the second mirror M2 have rotated due to driving of the piezoelectric actuators 111, and in association with this, each piezoelectric element 112 has been deformed, a current according to the deformation flows in the piezoelectric element 112 due to the piezoelectric effect. In general, it is known that the magnitude of the current that flows in the piezoelectric element 112 is proportional to the speed at which the piezoelectric element 112 expands and contracts. That is, the conduction current of the piezoelectric element 112 corresponds to the derivative of the expansion and contraction state of the piezoelectric element 112. Therefore, this conduction current corresponds to the rotational position of the second mirror M2, i.e., the scanning position of light in the vertical direction.

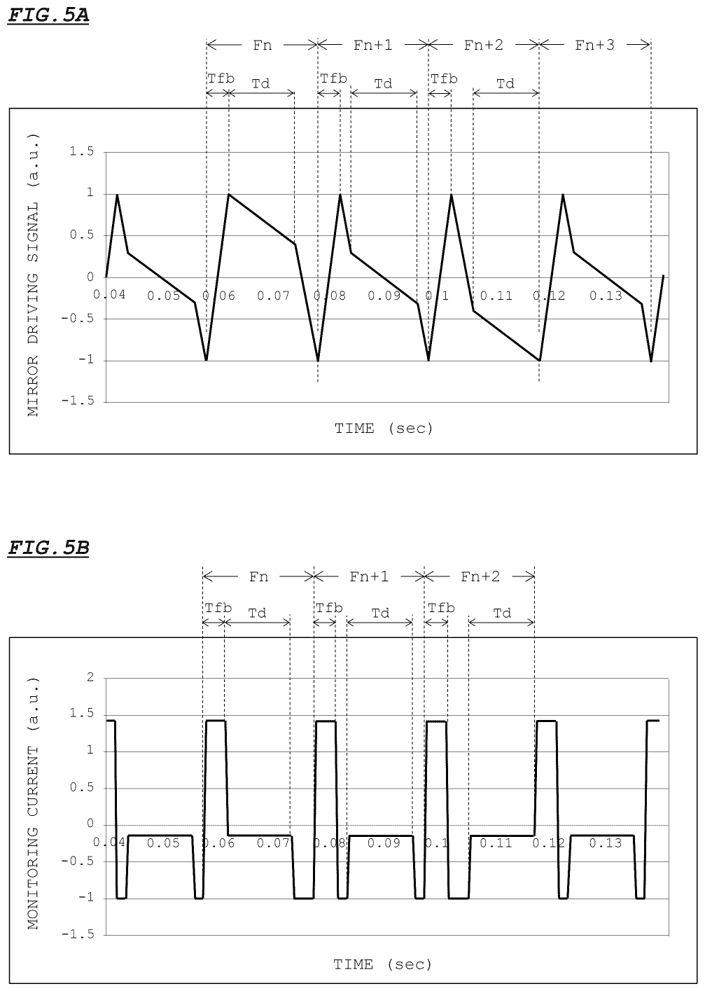

FIG. 5A shows a simulation waveform of a driving signal (voltage) applied to the piezoelectric actuator 111 when the rendering region of an image is changed in the vertical direction for each frame. FIG. 5B shows a waveform obtained through simulation of the current (monitoring current) that flows in the piezoelectric element 112 when the piezoelectric actuator 111 is driven by the driving signal in FIG. 5A. In FIG. 5A, the driving signal with respect to one piezoelectric actuator 111 is shown, and in FIG. 5B, the monitoring current that flows in one piezoelectric element 112 is shown.

For convenience, in FIG. 5A, the vertical axis is normalized with the maximum value and the minimum value of the driving signal. In FIG. 5B, the vertical axis is normalized with the current values corresponding to 1 and −1 in the vertical axis.

In FIG. 5A, Fn is the n-th frame period (the period for one frame). The frame period Fn includes: a flyback period Tfb in which the scanning position is returned from the scan end position in the frame period Fn−1 of the previous time to the scan start position in the frame period Fn of this time; and a rendering period Td for an image.

In all the frames, the slope of the driving signal in the rendering period Td, i.e., the scan speed in the vertical direction, is constant. The slope of the driving signal in the flyback period Tfb, i.e., the scan speed in the vertical direction, is also constant in all the frames. The slope of the driving signal in the period present between the flyback period Tfb and the rendering period Td is also constant in all the frames.

In this simulation, between frames adjacent to each other, the range of the driving signal in the rendering period Td is different. Specifically, as compared with the value of the driving signal at the end time point of the rendering period Td in the frame period Fn, the value of the driving signal at the start time point of the rendering period Td in the frame period Fn+1 is slightly smaller. In addition, as compared with the value of the driving signal at the end time point of the rendering period Td in the frame period Fn+1, the value of the driving signal at the start time point in the rendering period Td in the frame period Fn+2 is slightly smaller. The range of the driving signal in the rendering period Td in the frame period Fn+3 is the same as that of the frame period Fn+1. The frame period Fn+3 is cyclically followed by frame periods similar to the frame periods Fn to Fn+3.

In this manner, when the rendering period Td is set to each frame period, the range of the driving signal according to which an image is rendered, i.e., the range of the rendering region in the vertical direction, is cyclically switched in three levels, i.e., high, middle, and low.

In this case, the monitoring current flowing in the piezoelectric element 112 changes as shown in FIG. 5B. As described above, since the slope of the driving signal in the flyback period Tfb is constant, the monitoring current in the flyback period Tfb rises to a current value having a magnitude corresponding to this slope, and then becomes constant at this current value. In addition, since the slope of the driving signal in the rendering period Td is constant, the monitoring current in the rendering period Td falls to a current value having a magnitude corresponding to this slope, and then becomes constant at this current value. Since the slope of the driving signal in the period present between the flyback period Tfb and the rendering period Td is also constant, the monitoring current in this period becomes constant at a current value having a magnitude corresponding to this slope.

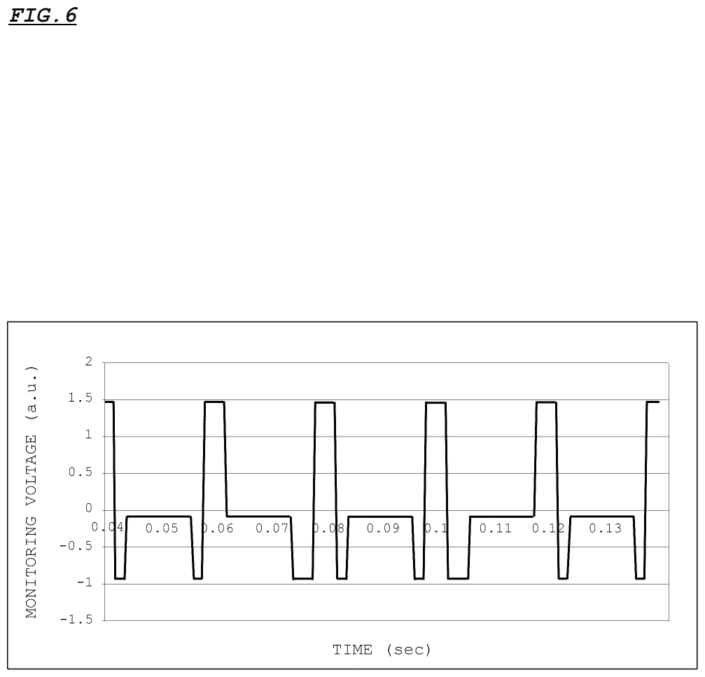

As shown in FIG. 5B, the monitoring current flowing in the piezoelectric element 112 has a waveform obtained through differentiation of the expansion and contraction state of the piezoelectric element 112 at the time when the piezoelectric actuator 111 has been driven by the driving signal in FIG. 5A. Therefore, when the monitoring current is converted into a voltage by an I/V converter, and the converted voltage is integrated by an integrator, the expansion and contraction state of the piezoelectric element 112, i.e., a detection signal indicating the scanning position of light in the vertical direction, can be acquired. When the monitoring current in FIG. 5B is converted into a voltage by an I/V converter, the waveform shown in FIG. 6 is obtained. This waveform is integrated by an integrator, whereby the detection signal is generated.

However, in this configuration, it takes some time until the integrated value by the integrator stabilizes. On the other hand, in the feedback control in which the image rendering position is caused to follow the line of sight of the user as in the present embodiment, it is preferable that the detection signal indicating the scanning position of light in the vertical direction can be generated within the frame cycle, i.e., a short period of 1/60 seconds, for example. Then, it becomes possible to cause the image rendering position to quickly and accurately follow change in the line of sight of the user.

As described above, by mere integration of the I/V-converted voltage performed by an integrator, the detection signal appropriate for feedback control for following the line of sight cannot be obtained since it takes time until the integrated value stabilizes.

Therefore, in the present embodiment, in order to make it possible to quickly and accurately generate the detection signal, the configuration of the mirror position detection circuit 45 is improved.

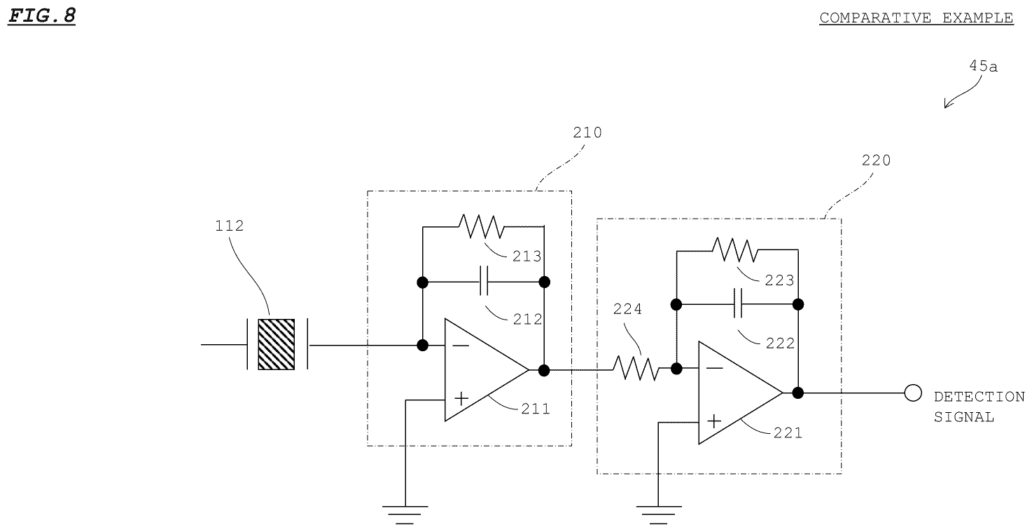

FIG. 7 shows a configuration of the mirror position detection circuit 45 according to the embodiment. For comparison, a configuration of a mirror position detection circuit 45a according to a comparative example is shown in FIG. 8.

First, with reference to FIG. 8, the mirror position detection circuit 45a according to the comparative example will be described.

The mirror position detection circuit 45a according to the comparative example includes an I/V converter 210 and an integrator 220.

The I/V converter 210 includes an operational amplifier 211, a capacitance 212, and a resistance 213. The monitoring current in the piezoelectric element 112 is inputted to the input terminal on the negative side of the operational amplifier 211. Between this input terminal and the output terminal of the operational amplifier 211, the capacitance 212 and the resistance 213 are connected in parallel, and the output of the operational amplifier 211 is fed back to the input. Accordingly, a voltage according to the magnitude of the inputted monitoring current is outputted from the operational amplifier 211.

The integrator 220 includes an operational amplifier 221, a capacitance 222, and resistances 223, 224. The output voltage of the I/V converter 210 is inputted to the input terminal on the negative side of the operational amplifier 221 through the resistance 224. Between this input terminal and the output terminal of the operational amplifier 221, the capacitance 222 and the resistance 223 are connected in parallel, and the output of the operational amplifier 221 is fed back to the input. Electric charge is accumulated in the capacitance 222, and integration is performed. By the two resistances 223, 224, the gain of the integrator 220 is determined. Then, the voltage obtained by integrating the output voltage from the I/V converter 210 is outputted as the detection signal from the operational amplifier 221.

Next, with reference to FIG. 7, the mirror position detection circuit 45 according to the embodiment will be described.

The mirror position detection circuit 45 according to the embodiment includes a first switch 231, a second switch 232, and an inverter 233 in addition to the configuration (the I/V converter 210, the integrator 220) in the comparative example shown in FIG. 8.

The first switch 231 and the second switch 232 are connected in parallel between the output and the input of the operational amplifier 221, and is switched from an open state to a closed state through application of a reset pulse at a high level to a terminal T1. The reset pulse is outputted by the controller 41 in FIG. 3 to the terminal T1. When the first switch 231 and the second switch 232 have been closed, the output and the input of the operational amplifier 221 are short-circuited, and the output and the input come to have the same potential. Accordingly, electric charge in the capacitance 222 is discharged to the ground through the operational amplifier 221, whereby the integrator 220 is reset.

The first switch 231 and the second switch 232 are respectively composed of elements complementary to each other. For example, the first switch 231 is implemented by an N-type transistor, and the second switch 232 is implemented by a P-type transistor.

The first switch 231 and the second switch 232 preferably have low resistance values when they are closed. Accordingly, the resistance values of these switches can be inhibited from influencing the gain of the integrator 220. In addition, the first switch 231 and the second switch 232 are preferably elements that have excellent interrupting characteristics when they are open. Accordingly, occurrence of an error in the integrated value due to leak in these switches can be inhibited.

The first switch 231 is switched to a closed state due to a high-level voltage signal. Therefore, to the first switch 231, the reset pulse inputted to the terminal T1 is applied as is. The second switch 232 is switched to a closed state due to a low-level voltage signal. Therefore, to the second switch 232, the reset pulse inputted to the terminal T1 is applied through the inverter 233. Thus, when the reset pulse at a high level has been applied to the terminal T1, both of the first switch 231 and the second switch 232 are simultaneously switched to a closed state. Unless the reset pulse is applied to the terminal T1, both of the first switch 231 and the second switch 232 are in an open state.

In the mirror position detection circuit 45a according to the comparative example shown in FIG. 8, it takes time until the integrated value by the integrator 220 stabilizes, as described above. Therefore, in this mirror position detection circuit 45a, the detection signal appropriate for quick feedback control such as causing the rendering region to follow the line of sight of the user as above, cannot be obtained.

In contrast, in the mirror position detection circuit 45 according to the embodiment, since the integrator 220 can be reset by the reset pulse, there is no need to wait until the integrated value by the integrator 220 stabilizes. Therefore, when this mirror position detection circuit 45 is used in detection of the scanning position of light in the vertical direction in the image generation device 3, the detection signal appropriate for quick feedback control for causing the rendering region to follow the line of sight of the user can be obtained.

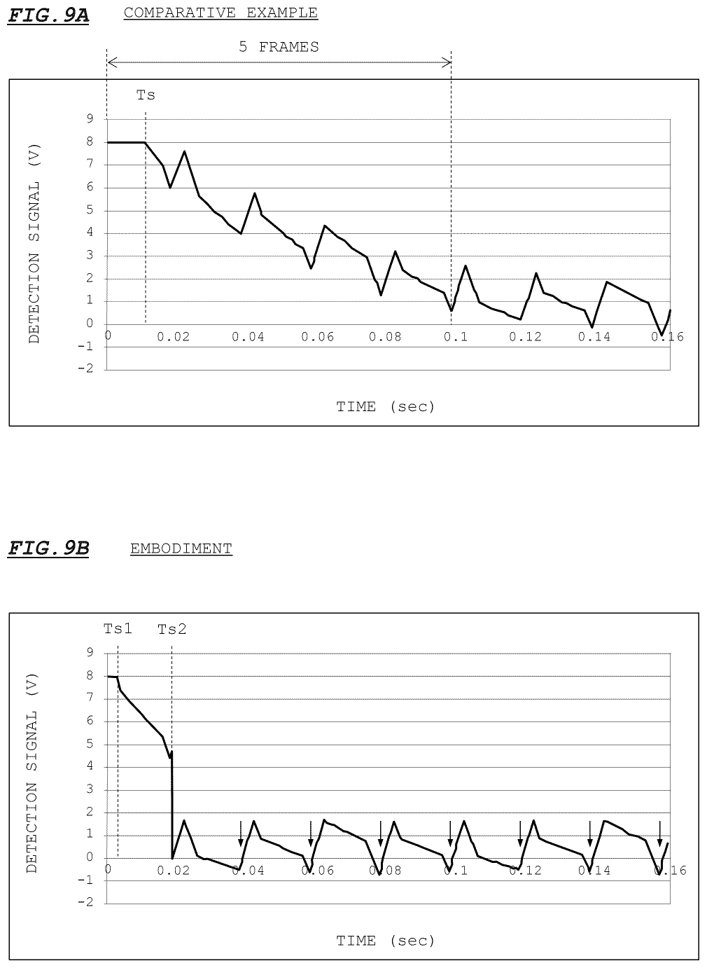

FIG. 9A shows a simulation waveform of the detection signal when the mirror position detection circuit 45a (FIG. 8) according to the comparative example is used.

The detection signal in FIG. 9A shows the detection signal outputted from the mirror position detection circuit 45a (the operational amplifier 221) in association with activation of the mirror position detection circuit 45a. That is, in FIG. 9A, in the configuration of the mirror position detection circuit 45a according to the comparative example, a simulation waveform of the detection signal outputted from the operational amplifier 221 due to activation of the mirror position detection circuit 45a is shown. Here, at a timing Ts in FIG. 9A, application of a monitoring voltage to the terminal on the negative side of the operational amplifier 221 is started. The waveform of the monitoring voltage from 0 seconds and thereafter is the same as the waveform of the monitoring voltage at 0.04 seconds and thereafter in FIG. 6. In the simulation, it is assumed that the monitoring voltage at the timing Ts and thereafter is inputted to the integrator 220.

As shown in FIG. 9A, at activation of the mirror position detection circuit 45a, the monitoring voltage is not applied yet from the I/V converter 210 to the terminal on the negative side of the operational amplifier 221. Therefore, immediately after the activation of the mirror position detection circuit 45a, a detection signal having a power supply voltage (here, 8 V), which is the operating voltage of the operational amplifier 221, is outputted from the operational amplifier 221. Then, at the timing Ts, when the monitoring voltage is started to be inputted to the operational amplifier 221, the amount of accumulated electric charge (integrated value) in the capacitance 222 changes in accordance with the inputted monitoring voltage, and the waveform of the output of the operational amplifier 221 gradually becomes close to the waveform obtained by integrating the monitoring voltage. In the example in FIG. 9A, it takes a period of approximately five frames until the output of the operational amplifier 221 stabilizes to the waveform obtained by integrating the monitoring voltage.

Thus, in the mirror position detection circuit 45a according to the comparative example, it takes some time until the output of the integrator 220, i.e., the detection signal, stabilizes.

In FIG. 9A, change in the waveform of the detection signal immediately after activation is shown. However, also when the rendering region is shifted in the vertical direction in accordance with change in the line of sight, it takes some time until the integrated value (detection signal) by the integrator 220 before the shifting stabilizes at a normal value after the shifting. Therefore, in the mirror position detection circuit 45a according to the comparative example, it is difficult to quickly output the detection signal appropriate for causing the rendering region to follow change in the line of sight of the user.

In the mirror position detection circuit 45a according to the comparative example, when the waveform of the monitoring voltage differs for each frame as in FIG. 6, influence of the monitoring voltage in the immediately preceding frame influences the detection signal in the present frame. Therefore, in the mirror position detection circuit 45a according to the comparative example, when the waveform of the driving signal has changed between frames, it is difficult to obtain an accurate detection signal for each frame.

FIG. 9B shows a waveform of the detection signal when the mirror position detection circuit 45 (FIG. 7) according to the embodiment is used.

The detection signal in FIG. 9B shows the detection signal outputted from the mirror position detection circuit 45 (the operational amplifier 221) in association with activation of the mirror position detection circuit 45. That is, in FIG. 9B, in the configuration of the mirror position detection circuit 45 according to the embodiment, a simulation waveform of the detection signal outputted from the operational amplifier 221 due to activation of the mirror position detection circuit 45 is shown.

At a timing Ts1 in FIG. 9B, application of the monitoring voltage to the terminal on the negative side of the operational amplifier 221 is started. As in the case of FIG. 9A, the waveform of the monitoring voltage at 0 seconds and thereafter is the same as the waveform of the monitoring voltage at 0.04 seconds and thereafter in FIG. 6. In the simulation, it is assumed that the monitoring voltage at the timing Ts1 and thereafter is inputted to the integrator 220.

Then, at a timing Ts2, the reset pulse is applied to the terminal T1 in FIG. 7. Through application of the reset pulse, electric charge in the capacitance 222 of the integrator 220 is discharged, whereby the integrator 220 is reset, as described above. Accordingly, the detection signal outputted from the integrator 220 (the operational amplifier 221) quickly falls to 0 V, and then, starting from 0 V, the detection signal according to the integrated value of the monitoring voltage is outputted from the integrator 220 (the operational amplifier 221).

Thus, in the mirror position detection circuit 45 according to the embodiment, in accordance with application of the reset pulse, the detection signal according to the integrated value of the monitoring voltage can be quickly outputted. Since the integrator 220 is reset by the reset pulse, the integrated value after the reset is not influenced by the integrated value before the reset. Therefore, in the mirror position detection circuit 45 according to the embodiment, the detection signal appropriate for causing the rendering region to follow change in the line of sight of the user can be quickly and accurately outputted.

In the simulation in FIG. 9B, the reset pulse is applied also at the timings indicated by arrows. That is, the reset pulse is applied to the mirror position detection circuit 45 for each frame. Accordingly, the integrated value in the frame of the previous time is inhibited from influencing the integrated value in the frame of this time.

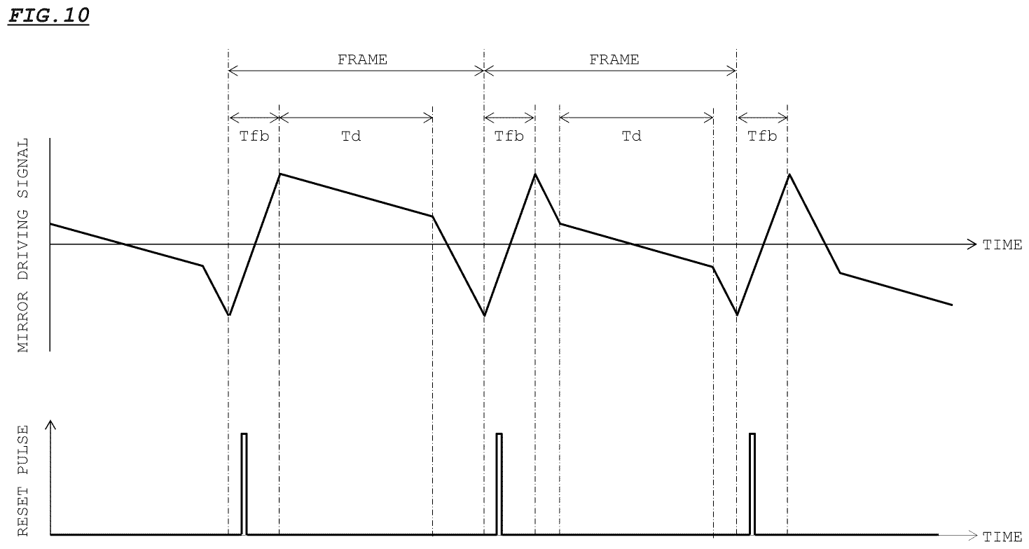

FIG. 10 is a time chart showing the application timing of the reset pulse according to the embodiment.

In the upper part of FIG. 10, the waveform of the driving signal for driving the second mirror M2 in the vertical direction is shown, and in the lower part of FIG. 10, the waveform of the reset pulse is shown.

As shown in FIG. 10, it is preferable that the reset pulse is applied to the terminal T1 in FIG. 7 in the flyback period Tfb of the driving signal. As described above, the flyback period Tfb is a period in which light is returned from the scan end position to the scan start position, and is a period that does not directly contribute to rendering of an image. Therefore, even if the reset pulse is applied in the flyback period Tfb to reset the integrator 220, rendering of the image is less likely to be influenced by the reset.

More specifically, the reset pulse has a predetermined time width, and thus, in the period thereof, the monitoring voltage inputted to the integrator 220 is not integrated. That is, by an amount corresponding to the period, the integrated value by the integrator 220 is deviated from the normal integrated value. Then, in the state where this deviation has occurred, the integrator 220 integrates the monitoring voltage. Accordingly, this deviation is gradually eliminated, and the integrated value gradually converges to the normal integrated value.

Therefore, if the reset pulse is applied in the rendering period Td, rendering of the image is directly influenced (due to deviation of the integrated value) by the reset of the integrator 220. In contrast, as described above, if the reset pulse is applied in the flyback period Tfb, rendering of the image is not directly influenced by the reset of the integrator 220, and the above-described deviation of the integrated value caused by the reset is substantially eliminated before the start of the rendering period Td.

Therefore, it is preferable that the reset pulse is applied to the terminal T1 in FIG. 7 in the flyback period Tfb of the driving signal, and from the viewpoint of eliminating the above-described error before the start of the rendering period Td, it is further preferable that the reset pulse is applied in the first half of the flyback period Tfb.

Since the reset pulse causes deviation in the integrated value as described above, it is preferable that the pulse width (time length) of the reset pulse is limited to the minimum necessary length as much as possible. That is, it is preferable to set the pulse width of the reset pulse to a minimum length at which the charged electric charge can be reliably discharged from the capacitance 222 of the integrator 220, or to a length slightly larger than this length.

In addition, it is preferable that the reset pulse is applied, in the flyback period Tfb, near the timing (the timing at which the second mirror M2 is positioned at a neutral position) at which the deflection angle with respect to the neutral position of the second mirror M2 in the vertical direction becomes zero. When the integrator 220 is reset, near a timing corresponding to the neutral position like this, variation in the waveform of the detection signal obtained after the reset can be suppressed.

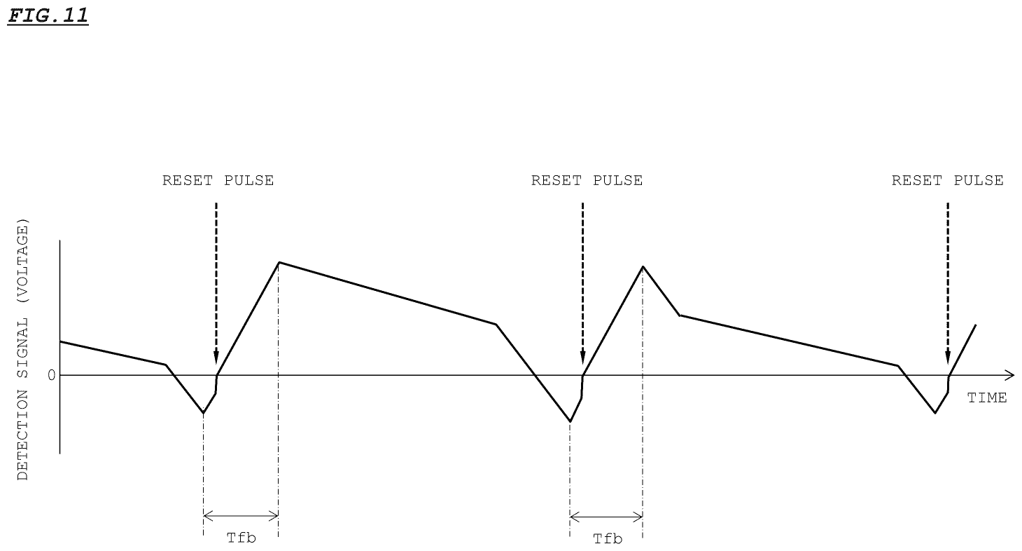

FIG. 11 shows a simulation waveform of the detection signal when the reset pulse is applied in the flyback period Tfb.

As shown in FIG. 11, through application of the reset pulse, the detection signal quickly converges to 0 V, and then, starting from 0 V, changes in a waveform similar to that of the driving signal in the upper part of FIG. 10. That is, the integrated value immediately before the application of the reset pulse does not influence the detection signal (integrated value) after the application of the reset pulse, and an integrated value according to the monitoring voltage after the application of the reset pulse is outputted as the detection signal.

Therefore, also when the line of sight of the user has changed and the rendering region is shifted in the vertical direction, if the reset pulse is applied in the flyback period Tfb for each frame, the detection signal according to the integrated value of the monitoring voltage can be accurately and quickly outputted. Therefore, in the mirror position detection circuit 45 according to the embodiment, the detection signal appropriate for causing the rendering region to follow change in the line of sight of the user can be quickly and accurately outputted.

In the examples in FIG. 10 and FIG. 11, for each flyback period Tfb, i.e., for each frame, the reset pulse is applied, whereby the integrator 220 is reset. However, the integrator 220 need not necessarily be reset for each frame.

For example, during a period of consecutive frames for which the position of the rendering region in the vertical direction is fixed, and in which the waveform of the driving signal for the second mirror M2 in the vertical direction is the same, the integrated value in the previous frame is less likely to influence the integrated value in the frame of this time. Therefore, in this period, the reset pulse need not necessarily be applied. On the other hand, during a period of consecutive frames for which the position of the rendering region in the vertical direction is changed, and in which the waveform of the driving signal for the second mirror M2 in the vertical direction is different, the integrated value in the previous frame is likely to influence the integrated value in the frame of this time. Therefore, in this period, control of applying the reset pulse for each frame may be performed.

Thus, during a period of consecutive frames in which the waveform of the driving signal for the second mirror M2 in the vertical direction is different, it is particularly preferable to apply the reset pulse for each frame. Accordingly, an accurate detection signal can be acquired for each frame.

### Effects of Embodiment

According to the embodiment above, the following effects are exhibited.

As shown in FIG. 7, the mirror position detection circuit 45 (detection circuit) includes: the I/V converter 210 that converts the conduction current flowing in the piezoelectric element 112 into a voltage; the integrator 220 that integrates the converted voltage; and the first switch 231 and the second switch 232 (switch) that reset the integrator 220 by use of a reset pulse.

According to this configuration, since the integrator 220 can be reset by the reset pulse, there is no need to wait until the integrated value by the integrator 220 stabilizes as in the mirror position detection circuit 45a (FIG. 8) according to the comparative example, as shown in FIGS. 9A, 9B. Therefore, when this mirror position detection circuit 45 (detection circuit) is used in detection of the scanning position of light in the vertical direction in the image generation device 3, the scanning position of light in the vertical direction can be quickly and accurately detected. Therefore, also when control of shifting, in the vertical direction, the rendering region in accordance with change in the line of sight of the user is performed as described above, the scanning position of light in the vertical direction can be smoothly and highly accurately controlled to a predetermined position, based on the detection signal from the mirror position detection circuit 45 (detection circuit).

As shown in FIG. 7, the mirror position detection circuit 45 (detection circuit) includes: the first switch 231 connected in parallel between the output and the input of the operational amplifier 221 included in the integrator 220; and the second switch 232 connected in parallel between the output and the input. The first switch 231 and the second switch 232 are respectively composed of elements complementary to each other. According to this configuration, ringing noises that respectively occur due to opening/closing of the first switch 231 and the second switch 232 are in opposite phases to each other, and thus, these ringing noises are canceled out. Therefore, the ringing noises can be inhibited from being superposed on the detection signal, and the quality of the detection signal can be enhanced.

In the example shown in FIG. 10 and FIG. 11, the controller 41 outputs the reset pulse to the mirror position detection circuit 45 (detection circuit) for each frame of a video signal. Accordingly, the integrated value acquired by the integrator 220 in the immediately preceding frame can be reliably prevented from influencing the integrated value acquired by the integrator 220 in the frame of this time. Since the controller 41 merely outputs the reset pulse for each frame, the process in the controller 41 can be simplified.

As shown in FIG. 4, the piezoelectric element 112 is placed so as to detect the scanning position of light in the vertical direction, and as shown in FIG. 10, the controller 41 outputs, to the mirror position detection circuit 45 (detection circuit), the reset pulse in the flyback period Tfb in which the scanning position is returned from the scan end position in the frame of the previous time to the scan start position in the frame of this time. Accordingly, as described above, the reset of the integrator 220 can be inhibited from influencing (due to deviation of the integrated value) the rendering of the image.

### Modification 1

In the embodiment above, as shown in FIG. 10, the reset pulse is applied to the mirror position detection circuit 45 (the terminal T1) in the flyback period Tfb. In contrast, in Modification 1, a DC period in which the driving signal for the second scanner 17 is made constant is set in the flyback period Tfb, and in this DC period, the reset pulse is outputted to the mirror position detection circuit 45.

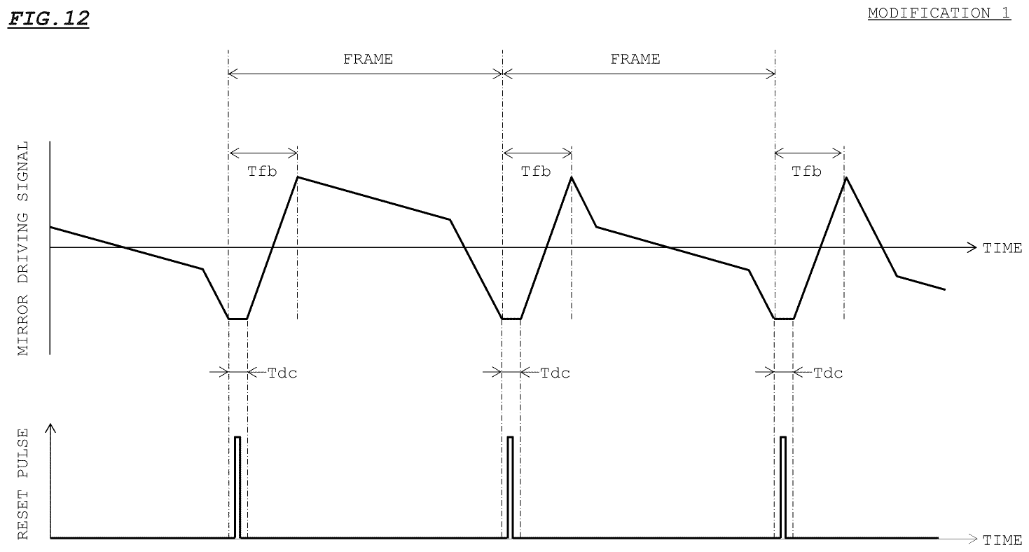

FIG. 12 is a time chart showing an application timing of the reset pulse according to Modification 1.

In the upper part of FIG. 12, the waveform of the driving signal for driving the second mirror M2 in the vertical direction is shown, and in the lower part of FIG. 12, the waveform of the reset pulse is shown. As shown in the upper part of FIG. 12, the controller 41 generates the driving signal such that a DC period Tdc is set in a part of the flyback period Tfb. Then, as shown in the lower part of FIG. 12, in this DC period Tdc, the controller 41 outputs the reset pulse to the mirror position detection circuit 45.

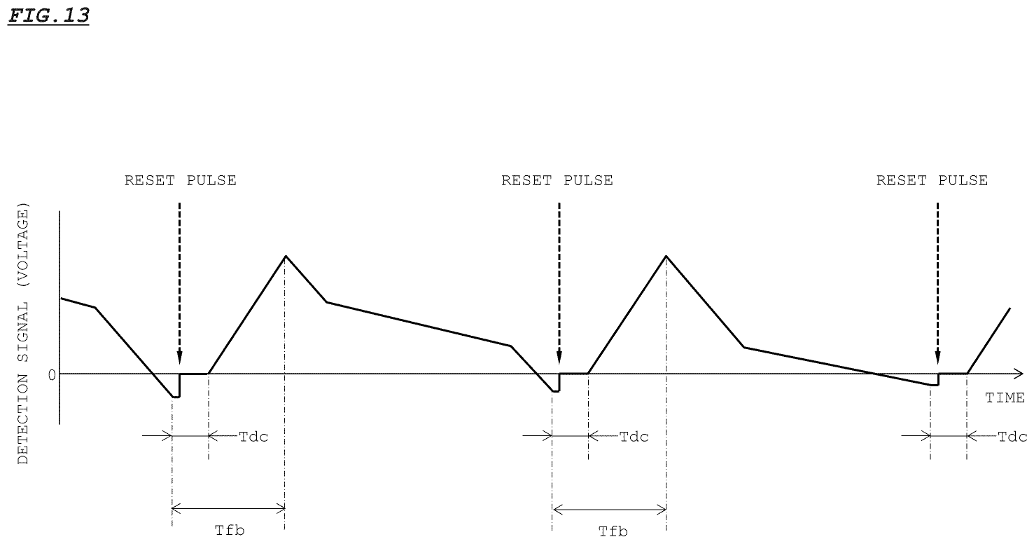

FIG. 13 shows a simulation waveform of the detection signal when the reset pulse is applied in the DC period Tdc.

As shown in FIG. 13, through application of the reset pulse, the detection signal quickly converges to 0 V, and then, starting from 0 V, changes in a waveform similar to that of the driving signal in the upper part of FIG. 12. At this time, since the reset pulse is included in the DC period Tdc, the monitoring voltage is maintained at 0 V in the period corresponding to the pulse width of the reset pulse. Therefore, in the period corresponding to the pulse width of the reset pulse, the normal integrated value by the integrator 220 does not change from 0 V, and even if the integrator 220 does not perform integration due to resetting in the period corresponding to the pulse width of the reset pulse, no deviation occurs between the normal integrated value and the integrated value by the integrator 220 after the application of the reset pulse.

Thus, with the configuration of Modification 1, deviation (deviation from the original detection signal) of the detection signal due to the reset pulse caused in the configuration of the embodiment above can be inhibited. Therefore, a more accurate detection signal can be acquired, and control based on the detection signal can be more accurately performed.

### Modification 2

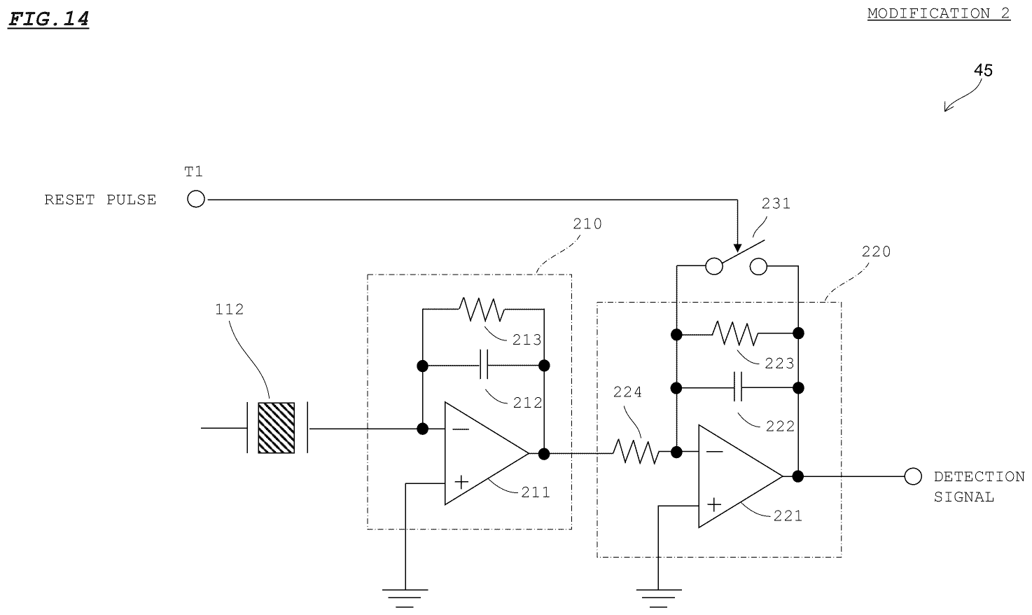

In the embodiment above, as shown in FIG. 7, two switches, i.e., the first switch 231 and the second switch 232, are used. However, either one of the switches may be omitted. For example, as shown in FIG. 14, the second switch 232 may be omitted, and the integrator 220 may be reset through closing operation of the first switch 231.

In this configuration as well, as in the embodiment above, the integrator 220 can be reset by the reset pulse.

However, this configuration may cause superposition, on the detection signal, of ringing noise that occurs during opening/closing of the first switch 231, as described above. Therefore, in order to eliminate this, as in the embodiment above, it is preferable that the first switch 231 and the second switch 232 composed of complementary-type elements are placed in parallel between the output and the input of the operational amplifier 221.

### Other Modifications

In the embodiment above, the resistance 223 is included in the integrator 220. However, the integrator 220 from which the resistance 223 is omitted may be used in the mirror position detection circuit 45.

In the embodiment above, as shown in FIG. 4, the piezoelectric element 112 is placed at the connection part of the drive part 102 connected to the support part 101. However, the position where the piezoelectric element 112 is placed is not limited thereto. The piezoelectric element 112 may be placed at a position where the rotational position (the scanning position of light) of the second mirror M2 can be appropriately detected.

In the embodiment and Modifications 1, 2 above, one of the two piezoelectric elements 112 has been described. However, the same configuration and control are applied to the other piezoelectric element 112 as well.

In the embodiment and Modifications 1, 2 above, the first mirror M1 and the second mirror M2 are separately provided. However, instead of the first mirror M1 and the second mirror M2, one mirror that rotates about two axes may be provided. In this case, at a drive part that causes this mirror to rotate in the vertical direction, a piezoelectric element 112 for mirror position detection may be placed.

In the embodiment above, the detection circuit of the present invention is used for detection of the scanning position of light in the vertical direction. However, the detection circuit of the present invention may be used for detection of the scanning position of light in the horizontal direction. In this case, the piezoelectric element 112 is placed in the first scanner 15, and the conduction current outputted from the piezoelectric element 112 during driving of the first scanner 15 is inputted to the I/V converter 210 in FIG. 7.

In the embodiment above, an example in which the present invention is applied to the image generation device 3 mounted to the AR glasses 1 has been shown. However, the image generation device to which the present invention is applied is not limited thereto. The detection circuit according to the present invention can also be used in various devices as long as the current outputted due to the piezoelectric effect from the piezoelectric element is used.

Various modifications can be made as appropriate to the embodiment of the present invention, without departing from the scope of the technological idea defined by the claims.

### Additional Notes

The following technologies are disclosed by the description of the embodiment above.

### (Technology 1)

A detection circuit comprising:
an I/V converter configured to convert a conduction current flowing in a piezoelectric element into a voltage;
an integrator configured to integrate the voltage; and
a switch configured to reset the integrator by use of a reset pulse.

According to this technology, since the integrator can be reset by the reset pulse, there is no need to wait until the integrated value by the integrator stabilizes. Therefore, when this detection circuit is used in detection of the scanning position of light in the image generation device, the scanning position of light can be quickly and accurately detected.

### (Technology 2)

The detection circuit according to technology 1, wherein
the switch includes
   a first switch connected in parallel between an output and an input of an operational amplifier included in the integrator, and
   a second switch connected in parallel between the output and the input, and
the first switch and the second switch are respectively composed of elements complementary to each other.

According to this technology, ringing noises that respectively occur due to opening/closing of the first switch and the second switch are in opposite phases to each other, and thus, these ringing noises are canceled out. Therefore, the ringing noises can be inhibited from being superposed on the detection signal, and the quality of the detection signal can be enhanced.

### (Technology 3)

An image generation device comprising:
a light source;
a scanner configured to perform scanning with light emitted from the light source;
a detection circuit configured to detect a scanning position of the light; and
a controller configured to control the light source and the scanner, based on a video signal, wherein
the scanner comprises a piezoelectric element for detecting the scanning position of the light,
the detection circuit comprises
   an I/V converter configured to convert a conduction current flowing in the piezoelectric element into a voltage,
   an integrator configured to integrate the voltage, and
   a switch configured to reset the integrator by use of a reset pulse, and
the controller outputs the reset pulse to the detection circuit at a predetermined timing to cause the switch to operate.

According to this technology, since the scanning position of light is detected by the detection circuit having a configuration similar to that of technology 1 above, the scanning position of light can be quickly and accurately detected. Therefore, for example, also when control of shifting the rendering region is performed, the scanning position of light can be smoothly and highly accurately controlled to a predetermined position, based on the detection signal from the detection circuit.

### (Technology 4)

The image generation device according to technology 3, wherein
the switch includes
   a first switch connected in parallel between an output and an input of an operational amplifier included in the integrator, and
   a second switch connected in parallel between the output and the input, and
the first switch and the second switch are respectively composed of elements complementary to each other.

According to this technology, effects similar to those in technology 2 above can be exhibited.

### (Technology 5)

The image generation device according to technology 3 or 4, wherein
the controller outputs the reset pulse to the detection circuit for each frame of the video signal.

According to this technology, the integrated value acquired by the integrator in the immediately preceding frame can be reliably prevented from influencing the integrated value acquired by the integrator in the frame of this time. Since the controller merely outputs the reset pulse for each frame, the process in the controller can be simplified.

### (Technology 6)

The image generation device according to any one of technologies 3 to 5, wherein
the piezoelectric element is placed so as to detect a scanning position of light in a vertical direction, and
the controller outputs, to the detection circuit, the reset pulse in a flyback period in which the scanning position is returned from a scan end position in a frame of a previous time to a scan start position in a frame of this time.

According to this technology, the reset of the integrator by the reset pulse can be inhibited from influencing the rendering of the image.

### (Technology 7)

The image generation device according to technology 6, wherein
the controller sets, in the flyback period, a DC period in which a driving signal in the vertical direction is made constant, and outputs, in the DC period, the reset pulse to the detection circuit.

According to this technology, occurrence of deviation in the detection signal due to the reset pulse can be inhibited. Therefore, a more accurate detection signal can be acquired, and control based on the detection signal can be more accurately performed.

What is claimed is:

1. A detection circuit comprising:
an I/V converter configured to convert a conduction current flowing in a piezoelectric element into a voltage;
an integrator configured to integrate the voltage; and
a switch configured to reset the integrator by use of a reset pulse.

2. The detection circuit according to claim 1, wherein
the switch includes
a first switch connected in parallel between an output and an input of an operational amplifier included in the integrator, and
a second switch connected in parallel between the output and the input, and
the first switch and the second switch are respectively composed of elements complementary to each other.

3. An image generation device comprising:
a light source;
a scanner configured to perform scanning with light emitted from the light source;
a detection circuit configured to detect a scanning position of the light; and
a controller configured to control the light source and the scanner, based on a video signal, wherein
the scanner comprises a piezoelectric element for detecting the scanning position of the light,
the detection circuit comprises
an I/V converter configured to convert a conduction current flowing in the piezoelectric element into a voltage,
an integrator configured to integrate the voltage, and
a switch configured to reset the integrator by use of a reset pulse, and
the controller outputs the reset pulse to the detection circuit at a predetermined timing to cause the switch to operate.

4. The image generation device according to claim 3, wherein
the switch includes
a first switch connected in parallel between an output and an input of an operational amplifier included in the integrator, and
a second switch connected in parallel between the output and the input, and
the first switch and the second switch are respectively composed of elements complementary to each other.

5. The image generation device according to claim 3, wherein
the controller outputs the reset pulse to the detection circuit for each frame of the video signal.

6. The image generation device according to claim 3, wherein
the piezoelectric element is placed so as to detect a scanning position of light in a vertical direction, and
the controller outputs, to the detection circuit, the reset pulse in a flyback period in which the scanning position is returned from a scan end position in a frame of a previous time to a scan start position in a frame of this time.

7. The image generation device according to claim 6, wherein
the controller sets, in the flyback period, a DC period in which a driving signal for the scanner is made constant, and outputs, in the DC period, the reset pulse to the detection circuit.
